(19) United States
(12) Patent Application Publication
(10) Pub. No.: US 2014/0107834 A1
(43) Pub. Date: Apr. 17, 2014

(54) PROCESS AND APPARATUS FOR ALIGNING OBJECTS

(71) Applicant: KAMMANN MASCHINENBAU GMBH, BAD OEYNHAUSEN (DE)

(72) Inventors: Dietrich Rodefeld, Hilter (DE); Christian Maas, Herford (DE)

(73) Assignee: KAMMANN MASCHINENBAU GMBH, BAD OEYNHAUSEN (DE)

(21) Appl. No.: 14/050,608

(22) Filed: Oct. 10, 2013

(30) Foreign Application Priority Data
Oct. 10, 2012 (DE) 10 2012 218 481.3

(51) Int. Cl. B65G 47/244

(52) U.S. Cl. CPC B65G 47/244
USPC 700/230

(57) ABSTRACT

The invention relates to a process for aligning an object such as a hollow body in which the object is fed to an aligning and/or positioning device by means of a conveyor system such as a conveyor belt, wherein the actual orientation and actual position of the object is determined by means of an image acquisition system comprising a camera and software run on a computer for evaluating a camera picture of the object, and the orientation and/or positioning device is controlled in response to said evaluation in order to change the actual orientation and actual position of the object to a desired orientation and/or desired position. The invention also relates to an apparatus for carrying out such a process.

The invention relates to a process and apparatus for aligning an object such a hollow body, wherein said object is fed to an aligning and/or positioning device by means of a conveyor system such as a conveyor belt, wherein the actual orientation and actual position of an object are determined by means of an image acquisition system comprising a camera and software run on a computer for the evaluation of a camera picture of the said object, and said aligning and/or positioning device is controlled in response to said evaluation in order to change the actual orientation and/or actual position of the object to a desired orientation and/or desired position.

A conventional process of the kind described and an associated apparatus are known for instance in the field of surface treatment, e.g. the decoration of hollow bodies like bottles, glasses, small bottles etc. made of glass, plastic material or metal, e.g. composite materials. Here the hollow bodies are supplied via conveyor belts to the respective machines that carry out said decoration process or to upstream and downstream processes in connection with said decoration. Such machines can for example be screen printing machines, pad printing machines, inkjet printing machines, film hot transfer machines, surface treatment machines etc. Normally, in the entry region of such surface treatment machines an aligning and/or positioning device is disposed for correctly positioning and/or orienting said hollow bodies on conveyor belts thereby enabling a usually arranged gripper that functions as the aligning and/or positioning device to grab the hollow bodies and supply them to the surface treatment process. Here the image data about the actual orientation and actual position of the hollow body collected by a camera are used for controlling said aligning and/or positioning device. The more accurately said actual orientation and/or actual position can be determined, the more precise and gentle said control is. If the actual orientation or actual position of the object is determined insufficiently, this may lead to that sensitive surfaces of the object are damaged by said aligning and/or positioning device under these circumstances.

Up to present, an all-embracing use of robots detecting the object such as a hollow body by means of a camera picture and thereafter positioning the object failed particularly due to an illumination that can be employed all-round. For example, the geometries of the objects or hollow bodies which are frequently very different, especially in the case of a glass material, exhibit strongly varying optical reflection and transmission properties in industrial production environments which normally require individual illumination arrangements adjusted to the respective object. Moreover, there may be objects that had been previously subject to a surface treatment, such as varnished, calendered or etched objects, and that now require a surface finishing treatment. In this case, the changing nature of the surface alone already leads to different illumination requirements, even if the geometry of the object remains unchanged.

The invention is based on the object of improving the conventional process for aligning an object as well as an associated apparatus for carrying out the process to that effect that both can be used in a universal manner.

Surprisingly, on part of the process, said object is already achieved by a process for aligning an object comprising the features of claim 1. The process of the invention is characterized in that object image data are recorded using an infrared camera, which image data are evaluated and processed for the determination of the actual orientation and/or actual position of the object, and wherein the object is changed in respect of the temperature thereof at least partially using a heat or cold source prior to recording said image data. Here the object functions as a source of heat radiation that is detected by said infrared camera.

The process of the invention allows the actual orientation and/or actual position of the object to be determined more accurately than in the conventional process in a great number of specific aligning situations so that the aligning and/or positioning device can be more accurately adjusted for the respective aligning and/or positioning problem, whereby particularly damage to the surface of the object during its alignment can be substantially avoided. Also, in a great number of applications, the provision of individual illumination arrangements adjusted to the respective object can be dispensed with because the object image data recorded by means of an infrared camera enable good differentiation of certain parts of the object from other parts of the object or good differentiation of the whole object from an image background. These possibilities of differentiation are achieved by changing the object in respect of the temperature thereof at least partially using a heat or cold source for increasing the contrast prior to recording said image data.

Further embodiments and features essential to the invention will be discussed in the following general description, the description of the Figures as well as in the independent apparatus claim and in the subclaims.

The aligning and/or positioning device can be constructed for example as a robot system or as a stop-and-slide system.

Preferably, the process of the invention is configured such that the image information is limited to different temperature regions, which simplifies discrimination or differentiation of sections or parts of the object or discrimination or differentiation of the object from the background. Insofar the image information is reduced to temperature gradients within the image.

To achieve an increase in contrast or better differentiability of object details or of the object from the image background in the object image data recorded by means of the infrared camera and to thereby improve the determination of the actual orientation and/or actual position of the object at the processing of these image data, the invention may provide that the surface temperature of the object is changed at least partially also during the recording of a camera picture. This can take place for example by exposing the object to irradiation from an infrared radiation source. Depending on the specific detection problem, said irradiation with respect to the object can take place also partially, but in a specific embodiment it is also possible to irradiate the object over the full surface thereof using one or more infrared sources. Here it can also be provided for the object being irradiated from several directions, particularly over a large dihedral angle.

It shall be understood that according to the invention the surface temperature of the object can also be changed by the use of a cold source at least partially in order to obtain an increase in contrast or better differentiation within details of the object or of the object from the background.

In a similar manner, it can also be preferable if for increasing the contrast or for better differentiation of the object from the background, the surface temperature of the background of the object is changed at least in sections prior to recording a camera picture of the object. Such a modification can be made using a heat and/or cold source.

For still further improving the differentiation of the object in the image data from the image background, it can be provided that for recording the object by the camera the background is designed in such a manner that its emissivity with respect to the infrared radiation detected by the camera is different from the emissivity of at least a section of the object by a minimum of 10%, preferably by at least 20% and particularly preferably by at least 30%.

Preferably, prior to recording a camera picture the object can be exposed to a radiation-active source with the consequence that the object is cooled at least partially as a result of a radiation imbalance between the object and the cold source. According to the invention, such cooling, in particular partial cooling of the object, i.e. cooling of a surface section of the object, can also be effected using an air jet that is applied against the object. In a similar manner, a heated air jet can be used for heating the object.

A particularly good determination of the actual orientation and/or actual position of the object can be obtained by not only recording object pictures using an infrared camera and subject these to data processing, but also by processing image data that have been recorded using a camera working in the visible region. Here the evaluation software can utilize both data of an object image in the IR region and data of an object image in the visible region, for the determination of the actual orientation and/or actual position of the object. Preferably, the image data in the IR region or in the visible region can be recorded simultaneously, which makes data processing easier. Here it can be particularly useful if a camera arrangement is employed that is adapted for recording pictures both in the visible region and IR region and providing the corresponding image data for further processing.

Making picture recordings of the object within two different electromagnetic spectral regions, namely in the IR and visible regions, and subsequently processing both image data, affords a precision in the determination of the actual orientation and/or actual position of the object and accordingly in the alignment of the object which has not been achieved before.

Preferably, the spectral region utilized by the infrared camera can be within an interval of approx 3.5 μm to 15 μm. On the other hand, utilizing a very narrow band spectral region in the IR region, for example smaller than 1 μm within the stated interval, is also comprised within the scope of the invention.

Moreover, it can be generally useful if a plurality of pictures of the object are recorded using the infrared camera and are subsequently data-processed for determining the actual position and/or actual orientation of the object. Thus it is possible to detect and finally use for the orientation of the object also time-based changes of the position coordinates of the object caused for example by band-conveyors running in an inclined or curved manner, while the object passes through the field of vision of the infrared camera.

In an advantageous embodiment of the process according to the invention it can be provided that the object is changed in respect of the temperature thereof at least partially by a heat or cold source that is installed on the opposite side of its platform, with object pictures for further processing being taken from above or below said platform. Here the term platform is understood to mean a curved or plane surface by which the object is supported with respect to the underground, i.e. the conveyor system. The term partially is understood to mean a section of the object, in particular a section of its surface.

In a further advantageous embodiment it can also be provided to change the object in respect of the temperature thereof at least partially by a heat or cold source that is installed laterally to the object, with an object picture being taken from the lateral side. Here the term laterally is understood to mean laterally or from the side approximately vertical to the platform of the object so that in this embodiment lateral views of the object are recorded and used at first for the determination of the actual orientation and/or actual position.

Preferably, the process of the invention can also be configured for the determination of the type of object so that by means of the process of the invention different objects such as differently shaped hollow bodies can be processed simultaneously, arranged for example in different desired positions and desired orientations or supplied to different surface treatment machines. Here the contour of the respective object can be detected and the detected contour of the object compared to a plurality of previously determined object contours of the different object types stored in a memory in order to identify the object type of the respective object. Moreover, the process of the invention can also be used for determining geometrical data such as the height and/or width of the object which can also be used for the identification of the object type.

On part of the apparatus, the above-mentioned problem of conventional apparatus is solved by a conveyor system such as a belt conveyor, by an infrared camera including evaluation software, a data processing system including a control device as well as an aligning system such as a robot. The terms infrared camera and thermographic camera are used herein as synonyms. Further, the apparatus of the invention comprises a heat or cold source for changing the object in respect of the temperature thereof at least partially prior to recording image data. In a further development, the apparatus of the invention can also comprise a heating or cooling device for changing the surface temperature of the picture background. That picture background can for example be provided by a disc-like or two-dimensional installation.

Some embodiments of the invention will now be described with reference to the attached drawing figures, wherein it is shown by

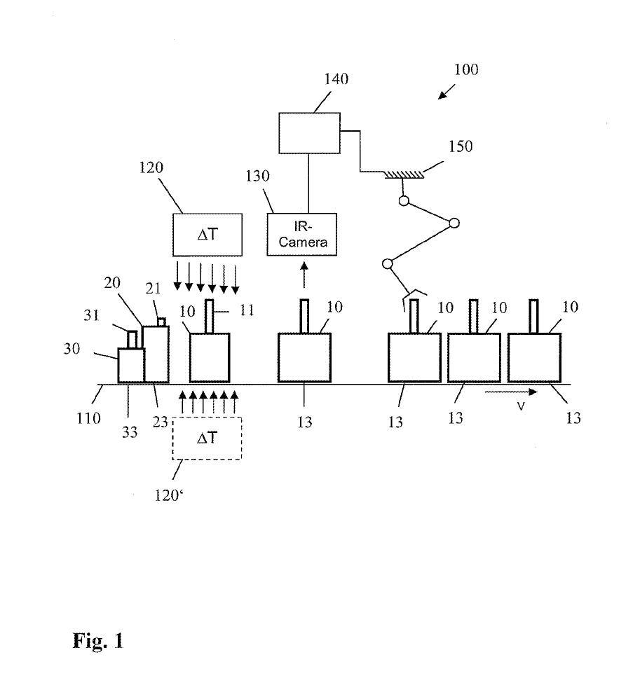

FIG. 1 a detail of an apparatus of the invention in a first embodiment in a lateral view;

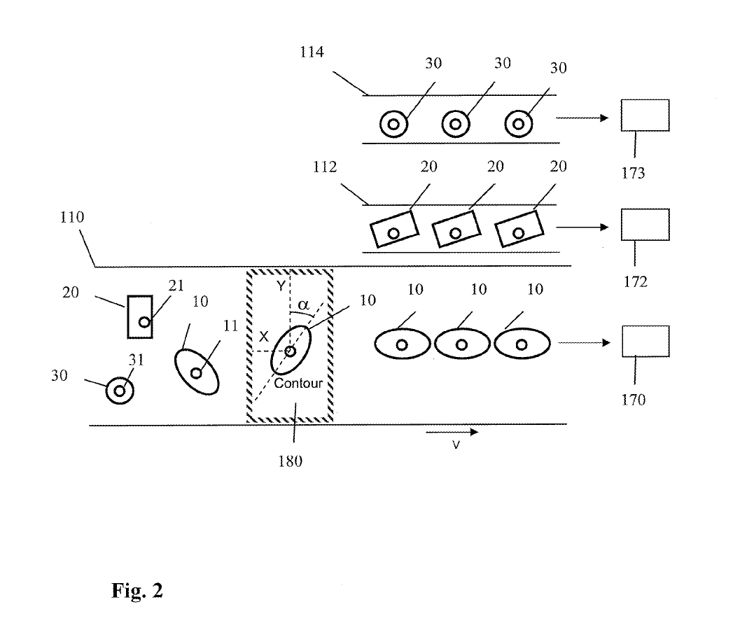

FIG. 2 the apparatus illustrated in FIG. 1 in a top view;

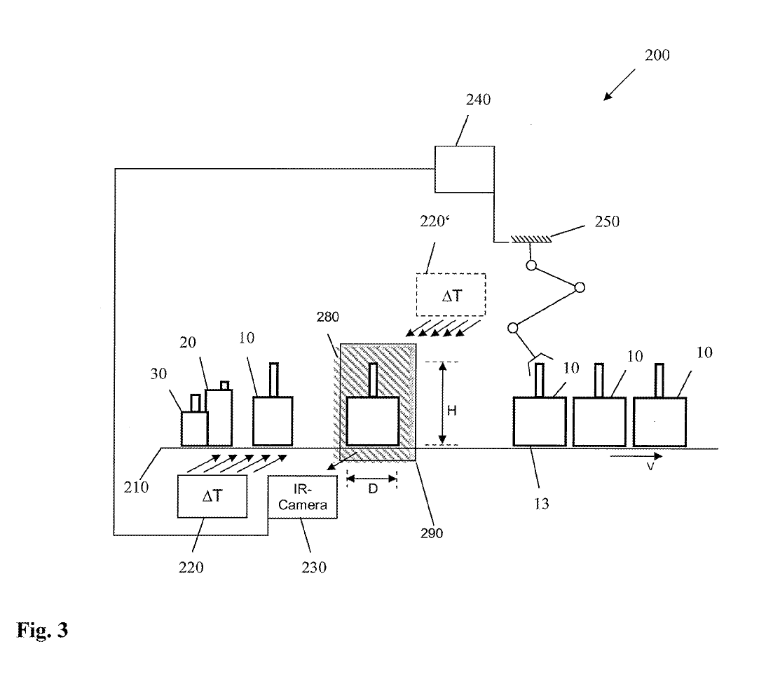

FIG. 3 a detail of an apparatus of the invention in a second embodiment in a lateral view;

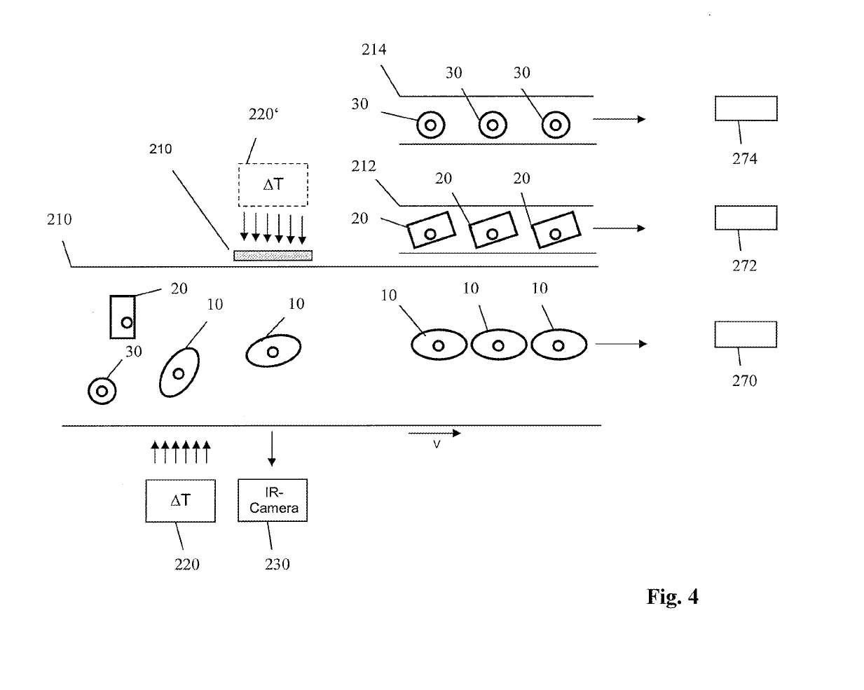

FIG. 4 the apparatus shown in FIG. 3 in a top view.

FIG. 1 shows in a schematic diagram of a detail of the apparatus 100 configured in accordance with the invention for carrying out a process according to the invention for aligning a hollow glass body 10, 20, 30, which is fed by means of the feed band or conveyor belt 110 of an aligning and positioning device that is configured as a robot system. In the described embodiment, the robot system 150 sets a predetermined desired orientation and desired position of the respective hollow glass body in which the object is fed to a respectively associated printing machine.

The apparatus 100 which is constructed according to the invention is adapted for not only detecting the actual orientation and the actual position of an object and for setting a predetermined desired position and desired orientation of the objects, but it can also differentiate between various types of glass objects 10, 20, 30, in the present case hollow glass bodies in the form of bottles. Here the apparatus is adapted for feeding each hollow glass body to a printing machine that is assigned to the respective type of hollow body.

FIG. 2 shows the apparatus illustrated in FIG. 1 and constructed in accordance with the invention in a top view. As apparent from FIGS. 1 and 2, three different types of hollow glass bodies 10, 20, 30 are initially fed to a stationary infrared source 120 in an arbitrary sequence, orientation and position by means of the conveyor belt 120, wherein the different hollow glass bodies 10, 20, 30 are supported on the conveyor belt 110 via dedicated platforms 13, 23, 33. In the embodiments according to FIGS. 1 and 2, the objects are irradiated from the top, i.e. from the side opposite the respective platform, by means of a conventional stationary infrared source 120 so that the respective hollow glass bodies become heated at their temporarily irradiated surfaces in dependence of the irradiation length of time that is determined by the velocity of conveyor belt as well as lateral extension of the heat source in the moving direction of the hollow glass bodies. This heating process leads to a temperature gradient on said hollow body and/or compared to the conveyor belt 110 which is detected by an infrared camera 130 arranged in a stationary manner on the downstream side with respect to the moving direction. In the FIGS. 1 and 2, there is optionally shown a cold source 120′ below the platform 33 of hollow glass body 30 which cools the conveyor belt 110 in the region of the platform 33 and thus provides for a higher contrast between the hollow glass body 30 as well as the region of the conveyor belt 110 that is moved and on which the hollow glass body is supported. This leads to an improved differentiability between the actual object and the image background that is provided in the embodiment described by the conveyor belt 110 or by the part of the conveyor belt 110 on which the object is supported. Incidentally, the relative position of the conveyor belt 110 and the object supported thereon does not change during the movement of the belt between the heating stage of the hollow glass body and the camera recording. The part of the conveyor belt which forms the image background is denoted by reference number 180 in FIG. 2.

The image data collected by the camera 130 are processed in a control device 140 for determining the actual orientation and actual position of the hollow glass bodies, wherein said control device then controls the downstream robot system 150 for grabbing the object that has been determined and for setting a predetermined desired orientation and desired position so that the respective object that has been recognized is fed to its related printing machine.

As apparent particularly from FIG. 2, in the embodiment described, three different hollow glass bodies 10, 20, 30 are conveyed via said conveyor belt 110 and image data are collected from each object by means of said infrared camera arranged on the opposite side of platform 13, 23, 33, which image data are utilized by control device 140 for determining the actual position, here identified by the coordinates X, Y in the plane of the conveyor belt, and for determining the orientation or alignment, here identified by an angle α of a main axis of the object to the Y axis in a plane that is defined by conveyor belt 110.

In the embodiment described, the evaluation software is adapted for detecting and differentiating said three possible types of hollow glass bodies. Since said three different types of glass bodies in the embodiment described have to be supplied to different printing processes, which are denoted by reference number 170, 172 or 173 in FIG. 2, said robot system 150 is adapted for placing each hollow glass body of the first type and in a first desired position and desired orientation onto conveyor belt 110 and additionally each hollow glass body 20 of the second type and in a predetermined position and orientation onto a second conveyor belt 112, and each hollow glass body 30 in a predetermined desired position and desired orientation onto a conveyor belt 114.

With the process or apparatus according to the invention it is possible to prevent the hollow glass bodies from touching each other so that their surfaces will not be damaged. Moreover, due to the very precise detection of the actual orientation and actual position of the respective hollow bodies, said robot system 150 can accurately grab the glass bodies, whereby surface damage on said hollow bodies can be avoided in turn.

Software adaption allows the apparatus or the process to be quickly changed with regard to different hollow bodies. Although not illustrated, in the course of further automation, one embodiment also enables the processing of hollow bodies from standardized and automatically charged/discharged carriers such as small pallets, thermo-molded trays etc. by the process or apparatus of the invention.

Here the term actual position refers to the position of the bottle neck of the respective hollow glass body projected onto the plane of the respective conveyor belt 110, 112 or 114. It shall be understood that depending on the particular case of application also different reference points inside or outside the respective object can be selected for determining the respective coordinates.

A further embodiment of a process for aligning an object and an associated apparatus for carrying out such process will be described in the following with reference to FIGS. 3, 4. In contrary to the embodiment according to FIGS. 1, 2, in which the irradiation and also the orientation of the camera take place vertically, the hollow glass bodies 10, 20, 30 in the present embodiment are irradiated laterally, and also the infrared camera is installed for lateral imaging of the respective object. The apparatus 200 again comprises a conveyor belt 210 by means of which hollow bodies 10, 20, 30 of three different types are fed to a robot system 250 that is controlled by a control device 240 for setting a predetermined actual orientation and actual position of the respective objects 10, 20, 30.

The objects are moved by means of the said conveyor belt 210 to a laterally arranged stationary infrared source 220, which heats the respective object. In the moving direction of the belt a laterally disposed downstream infrared camera 230 is provided for recording a lateral picture of the respective object, and on the laterally opposite side of the camera an artificial image background in the form of a panel 280 is arranged that can be cooled by means of a cold source 220′ for increasing the differentiability of the object from the image background. Due to the lateral recording of the hollow glass bodies, the evaluation software in the control device 240 not only is capable of determining the respective type, the actual position and the actual orientation of the respective hollow glass body, but additionally also its width and height dimensions D, H in the image plane of the infrared camera, see FIG. 3.

In the embodiment illustrated in the FIGS. 3, 4, the image background is implemented by a plate-like design 280, e.g. made of metal, wherein said plate is preferably arranged parallel to the image plane of the camera. Even in this horizontally working infrared source or camera, the temperature gradient within the hollow body and/or between the hollow body and the object background enables the recording of infrared images that can be evaluated and processed for the determination of the actual orientation and actual position of the respective object so that the robot system 250 can be controlled by the control device 240, for placing the respective object in a predetermined actual position and actual orientation onto a respectively assigned conveyor belt 210, 212, 214 so that the objects can be fed to their specific printing processes 270, 272, 274.

### LIST OF REFERENCE NUMBERS

10 hollow glass body
11 hollow glass body neck
13 platform
20 hollow glass body
21 hollow glass body neck
23 platform
30 hollow glass body
31 hollow glass body neck
33 platform
100, 110, 112 apparatus
114 conveyor belt
120 infrared source
120′ cold source
130 infrared camera
140 control device
150 robot system
200, 210, 214 apparatus
220 infrared source
220′ cold source
230 infrared camera
240 control device
250 robot system
V moving direction

1. Process for aligning an object such as a hollow body in which said object is fed to an aligning and/or positioning device by means of a conveyor system such as a conveyor belt, wherein the actual orientation and/or actual position of the object is detected by means of an image acquisition system comprising a camera and software running on a data processing system for the evaluation of a camera picture of said object, and said aligning and/or positioning device is controlled in response to said evaluation in order to change the actual orientation and actual position of the object to a desired orientation and/or desired position, characterized in that image data of the object are collected by means of an infrared camera and can be evaluated and processed for the determination of the actual orientation and/or actual position of the object and wherein the object is changed in respect of the temperature thereof at least partially by means of a heat or cold source in order to increase the contrast prior to the collection of said image data.

2. Process according to claim 1, characterized in that for increasing the contrast, the surface temperature of the background of the object is changed at least in sections prior to recording a camera picture.

3. Process according to claim 1, characterized in that the object is irradiated at least partially by means of an infrared source prior to recording a camera picture.

4. Process according to claim 1, characterized in that for camera recording, the background of the object is configured in such a manner that the emissivity is different from the emissivity of the object by at least 10%, preferably by at least 20% and particularly preferably by at least 30%.

5. Process according to claim 1, characterized in that the object is exposed to a radiation-active cold source prior to recording a camera picture.

6. Process according to claim 1, characterized in that an object picture is recorded using in addition to said infrared camera a camera that works in the visible region, wherein said evaluation software utilizes both data of object images in the IR region and data of object images in the visible region for determining the actual orientation and actual position of the object.

7. Process according to claim 1, characterized in that the type of the object is recognized, particularly by its contour.

8. Process according to claim 1, characterized in that a plurality of pictures of the single, moving object are recorded and processed.

9. Process according to claim 1, characterized in that the object is changed in respect of the temperature thereof at least partially using a heat or cold source placed laterally to the object, wherein an object picture is recorded from the side.

10. Process according to claim 1, characterized in that the geometrical dimensions such as the height or width of the object are determined.

11. Apparatus for aligning an object such as a hollow body, comprising:
a conveyor system for feeding the object to
an aligning and/or positioning device for aligning and positioning said object;
an image acquisition system comprising a camera for recording at least a camera picture of the object as well as
a data processing system on which software for the evaluation of a camera picture of the object is run for determining the object's actual orientation and/or actual position, wherein the aligning and/or positioning device is controlled in response to said evaluation in order to change the actual orientation and/or actual position of the object to a desired orientation and/or desired position, characterized in that the camera is designed as an infrared camera and further comprises a heat or cold source that is adapted for changing the object in respect of the temperature thereof at least partially prior to recording said image data.
